(19) United States
(12) Patent Application Publication
(10) Pub. No.: US 2009/0252198 A1
(43) Pub. Date: Oct. 8, 2009

(54) Temperature Sensor Adapted in Charge and Discharge Control Circuit of Secondary Battery

(76) Inventor: Tsai-Chung Yu, Tamshui chen (TW)

Correspondence Address: HDLS Patent & Trademark Services, P.O. BOX 220746, CHANTILLY, VA, 20153-0746, US

(21) Appl. No.: 12/062,771

(22) Filed: Apr. 4, 2008

(51) Int. Cl. G01K 7/01

(52) U.S. Cl. 374/178

(57) ABSTRACT

A temperature sensor adapted in a charge and discharge control circuit of a secondary battery, cooperates with a micro-controller of the charge and discharge control circuit. The temperature sensor is a non-polar temperature sensor manufactured by the semiconductor manufacturing technology. The temperature sensor includes a first signal pin, a second signal pin, a first thermal diode, and a second thermal diode paired with the first thermal diode. The positive electrode of the first thermal diode and the negative electrode of the second thermal diode, both connect to the first signal pin. The negative electrode of the first thermal diode and the positive electrode of the second thermal diode, both connect to the second signal pin. The temperature sensor is proofread easily, has a low manufacturing cost, consumes less power and has an excellent anti-interfere capability, etc.

### BACKGROUND

1. Field of the Invention

The present invention relates to a temperature sensor, and more specifically, to a semiconductor temperature sensor adapted in a charge and discharge control circuit of a secondary battery. The semiconductor temperature sensor may be cooperated with a micro-controller of the charge and discharge control circuit, and be configured for sensing the temperature of the secondary battery.

2. Description of the Related Art

In various rechargeable secondary batteries, lithium battery (also named as lithium-ion battery) has many advantages of small volume, high energy density, no memory effect, high iteration lifetime, high voltage, low self-discharge rate, etc., such that the lithium battery is widely used as a power of a portable electronic device.

Generally, the charge and discharge control circuit of the rechargeable secondary battery, may provide many protection functions for avoiding overcharge, overdischarge, overcurrent, and short circuit, etc. Thus momentarily monitoring the temperature of the rechargeable secondary battery, is very important for managing the capacitance and the charge and/or discharge operation to keep the rechargeable secondary battery in an excellent and safe condition. Therefore, the charge and discharge control circuit of the conventional rechargeable secondary battery, usually includes a power control circuit, a power management circuit and a temperature sensor for managing the rechargeable secondary battery based upon the temperature thereof.

The power management circuit usually employs a micro-controller, for example, MSP 430 type micro-controller manufactured by Texas Instruments Corporation, to perform the above function. The micro-controller cooperates with a temperature sensor configured for sensing the temperature of the secondary battery. The temperature sensor usually is a thermistor. However, the thermistor has a high manufacturing cost, and consumes more power. Furthermore, the thermistor has a bad anti-interfere capability since it calculates the temperature by the measuring-voltage technology.

What is needed, is providing a temperature sensor, which can solve the above problem.

### BRIEF SUMMARY

A temperature sensor in accordance with an exemplary embodiment of the present invention includes a first signal pin, a second signal pin, a first thermal diode, and a second thermal diode paired with the first thermal diode. The positive electrode of the first thermal diode and the negative electrode of the second thermal diode, both connect to the first signal pin. The negative electrode of the first thermal diode and the positive electrode of the second thermal diode, both connect to the second signal pin.

Preferably, the temperature sensor is a single-chip and compact semiconductor temperature sensor by integrating the first thermal diode and the second thermal diode by the semiconductor manufacturing technology. The thermal diode has a lower manufacturing cost, and consumes less power than the conventional thermistor. Furthermore the thermal diode has a more excellent anti-interfere capability since it employs the measuring-current technology to calculate the temperature.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, circuit view of a temperature sensor, in accordance with an exemplary embodiment of the present invention;

FIG. 2 is a schematic, exploded view of the temperature sensor of FIG. 1; and

FIG. 3 is a schematic view of a charge and discharge control circuit of a lithium battery using the temperature sensor, in accordance with an exemplary embodiment of the present invention.

### DETAILED DESCRIPTION

Reference will now be made to the drawings to describe exemplary embodiments of the present temperature sensor, in detail. The following description is given by way of example, and not limitation.

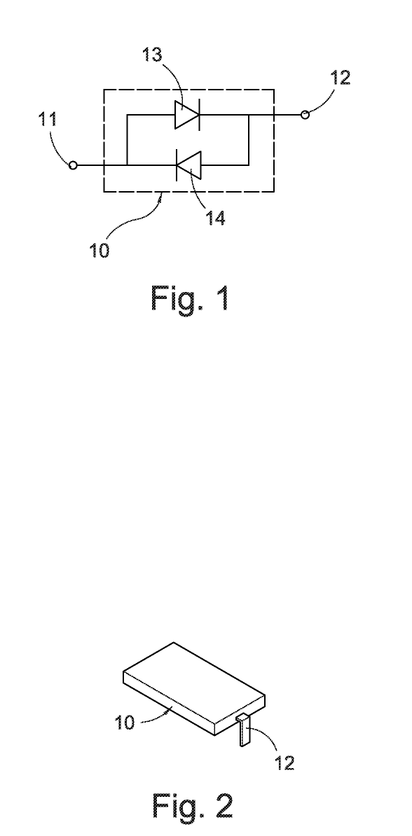

Referring to FIG. 1, a temperature sensor, in accordance with an exemplary embodiment of the present invention, in provided. The temperature sensor 10 includes a first signal pin 11, a second signal pin 12, a first thermal diode 13, and a second thermal diode 14 paired with the first thermal diode 13. The positive electrode of the first thermal diode 13 and the negative electrode of the second thermal diode 14, both connect to the first signal pin 11. The negative electrode of the first thermal diode 13 and the positive electrode of the second thermal diode 14, both connect to the second signal pin 12.

In this exemplary embodiment, the first thermal diode 13 and the second thermal diode 14 are integrated together by the semiconductor manufacturing technology to form a single-chip semiconductor temperature sensor 10 (as shown in FIG. 2). Furthermore, the single-chip semiconductor temperature sensor 10 is a temperature sensor without any polarity. That is, the electrodes of the single-chip semiconductor temperature sensor 10 may not be separated into the positive electrode or the negative electrode.

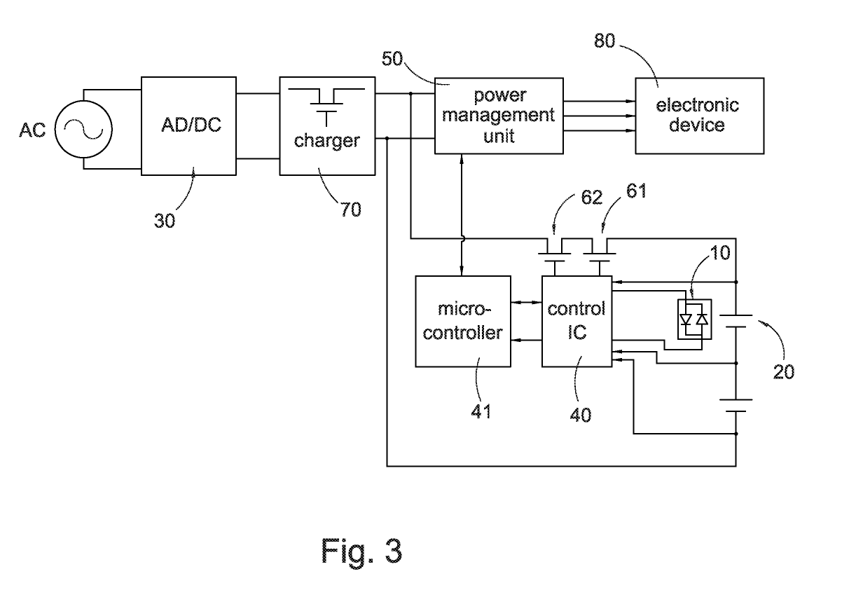

Referring to FIG. 3, a charge and discharge control circuit of a secondary battery, in accordance with another exemplary embodiment of the present invention, in provided. This present exemplary embodiment is just an example for describing how to employ the temperature sensor 10 into the charge and discharge control circuit of the secondary lithium battery, but not limitation. The charge and discharge control circuit thereof may be configured for providing power to an electronic device 80. The charge and discharge control circuit thereof includes two switches (such as MOS-FET) 61 and 62, an AC-DC (alternating current to direct current) converter 30, a control IC 40, a micro-controller 41, a power management unit 50, and a charger 70. The charge and discharge control circuit thereof is configured for charging power into a single battery or a group consisted of multi-batteries (employing the group 20 consisted of multi-batteries in this exemplary embodiment). The present temperature sensor 10 is arranged at a side of the group 20 consisted of multi-batteries. Preferably, the present temperature sensor 10 is attached on the side of the group 20 consisted of multi-batteries, or by other methods, for sensing the temperature of the group 20. The control IC 40 is configured for sensing the current values of the temperature sensor 10 at different temperatures, and controlling the on/off state of the switches (MOS-FET) 61 and 62. The control IC 40 converts the sensed current values into digital signals and transmits the digital signals to the micro-controller 41. Then the micro-controller 41 calculates the temperature of the group 20 consisted of multi-batteries, and transmits the temperature thereof to the power management unit 50. The two switches (MOS-FET) 61 and 62 are controlled by the micro-controller 42 with the cooperation of the power management unit 50 and the micro-controller 41, to charge and/or discharge the group 20 consisted of multi-batteries.

From the above, the exemplary embodiment of the present invention employ two thermal diodes connected head to end, to form a non-polar temperature sensor. The temperature sensor may be manufactured by the semiconductor manufacturing technology, such that it has a small volume, a low manufacturing cost, consumes less power. Furthermore, the present temperature sensor has an excellent anti-interfere capability since it employs the measuring-current technology to calculate the temperature.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

1. A temperature sensor adapted in a charge and discharge control circuit of a secondary battery, the temperature sensor being configured for sensing a temperature of the secondary battery, and the temperature sensor comprising:
a first signal pin;
a second signal pin;
a first thermal diode; and
a second thermal diode paired with the first thermal diode, the positive electrode of the first thermal diode and the negative electrode of the second thermal diode both connecting to the first signal pin, the negative electrode of the first thermal diode and the positive electrode of the second thermal diode both connecting to the second signal pin,
such that the first thermal diode and the second thermal diode are integrated together to form a single-chip non-polar semiconductor temperature sensor with each electrode capable of being used as a positive electrode or a negative electrode.

2. (canceled)
